(19) United States
(12) Patent Application Publication
(10) Pub. No.: US 2017/0018799 A1
(43) Pub. Date: Jan. 19, 2017

(54) FLEXIBLE LITHIUM SECONDARY BATTERY AND METHOD FOR MANUFACTURING THE SAME

(71) Applicant: Soongsil University Research Consortium Techno-Park, Seoul (KR)

(72) Inventor: Youngjin Jeong, Seoul (KR)

(21) Appl. No.: 15/281,625

(22) Filed: Sep. 30, 2016

Related U.S. Application Data
(63) Continuation of application No. PCT/KR2014/012827, filed on Dec. 24, 2014.

(30) Foreign Application Priority Data
Apr. 3, 2014 (KR) 10-2014-0039982

(51) Int. Cl. H01M 10/0525; H01M 4/66; H01M 10/058; H01M 10/0565

(52) U.S. Cl. CPC H01M 10/0525; H01M 10/0565; H01M 4/663; H01M 10/058; H01M 2300/0082

(57) ABSTRACT

A flexible lithium secondary battery and a method for manufacturing the same are provided. The flexible lithium secondary battery includes a cathode material, a solid electrolyte laminated on the cathode material, and an anode material laminated on the solid electrolyte. The cathode material is formed by including a cathode active material in a carbon nanotube film, and the anode material is formed by including a carbon nanotube film or including an anode active material in a carbon nanotube film.

This application is a continuation application of PCT Application No. PCT/KR2014/012827 filed on Dec. 24, 2014, which claims the benefit of Korean Patent Application No. 10-2014-0039982 filed on Apr. 3, 2014, the entire disclosures of which are incorporated herein by reference.

### BACKGROUND

The present disclosure relates to a flexible lithium secondary battery and a method for manufacturing the same.

A lithium secondary battery can be repeatedly charged and discharged with a high voltage and a high energy density and thus can be reused. Therefore, the lithium secondary battery has been widely used in small electronic devices, such as cellphones, laptops, and camcorders to electric cars, and is in increasing demand. Further, with the current trend of attaching small electronic devices to clothing or a body, or implanting small devices into a body, the devices are required to be flexible. However, a flexible electrode and a flexible solid electrolyte are typically needed to manufacture a flexible lithium secondary battery.

A carbon nanotube having a high electrical conductivity, a large capacity, and a low density has attracted a lot of attention as a material for a lithium secondary battery, and thus studies thereon are being actively conducted.

According to a conventional technology, a lithium secondary battery using a carbon nanotube is manufactured as follows. An anode active material, a polymer adhesive, and conductive carbon black are mixed into slurry, and the slurry is coated on a copper thin film to form an anode. Likewise, a cathode active material, a polymer adhesive, and conductive carbon black are mixed and then coated on an aluminum thin film to form a cathode. Then, a separation membrane and an electrolyte are placed between the anode and the cathode and then sealed to manufacture a lithium secondary battery.

The above-described example is disclosed in Korean Patent Laid-open Publication No. 10-2014-0019054 (entitled “Slurry comprising carbon nanotube for secondary battery and secondary battery comprising the same”).

### BRIEF SUMMARY

The present disclosure solves the above-described problem of the conventional technology, and provides a method for manufacturing a flexible lithium secondary battery available for use in various electronic devices, such as cellphones, smart cards, RFID tags, wireless sensors, and the like, using a carbon nanotube film.

However, problems to be solved by the present disclosure are not limited to the above-described problems. There may be other problems to be solved by the present disclosure.

According to an aspect of the present disclosure, a lithium secondary battery may include a cathode material, a solid electrolyte laminated on the cathode material, and an anode material laminated on the solid electrolyte. Herein, the cathode material is formed by including a cathode active material in a carbon nanotube film, and the anode material is formed by including a carbon nanotube film or including an anode active material in a carbon nanotube film.

According to another aspect of the present disclosure, a fiber-type lithium secondary battery may include an anode material, a solid electrolyte covering the anode material, and a cathode material covering the solid electrolyte. Herein, the cathode material is formed by including a cathode active material in a carbon nanotube film, and the anode material is formed into a fiber shape by twisting a carbon nanotube film or a carbon nanotube film including an anode active material.

According to yet another aspect of the present disclosure, a method for manufacturing a lithium secondary battery may include forming a cathode material by including a cathode active material in a carbon nanotube film, laminating a solid electrolyte on the cathode material, and laminating an anode material on the solid electrolyte. Herein, the laminating of an anode material is performed by including a carbon nanotube film or including an anode active material in a carbon nanotube film.

According to still another aspect of the present disclosure, a method for manufacturing a fiber-type lithium secondary battery may include forming an anode material into a fiber shape, covering the anode material with a solid electrolyte, and covering the solid electrolyte with a carbon nanotube film including a cathode active material. Herein, the forming of an anode material into a fiber shape may include manufacturing a carbon nanotube fiber by twisting a carbon nanotube film or a carbon nanotube film including an anode active material and manufacturing an anode material by winding the carbon nanotube fiber in the form of coil around a conducting wire.

According to any one of the aspects of the present disclosure, a polymer adhesive and conductive agent are not used in manufacturing a lithium secondary battery. Thus, the lithium secondary battery may have a large capacity and an electronic device using, the lithium secondary battery can have lighter weight.

Further, according to any one of the aspects of the present disclosure, it is possible to manufacture a flexible lithium secondary battery which can be folded or knotted.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 illustrates a structure of a lithium secondary battery in accordance with an exemplary embodiment.

FIG. 2 is a flowchart provided to explain a method for manufacturing a lithium secondary battery in accordance with an exemplary embodiment in detail.

FIG. 3 is a schematic diagram illustrating a process for manufacturing a carbon nanotube film in accordance with an exemplary embodiment.

FIG. 4 is an electron microscopic image of a carbon nanotube film manufactured in accordance with an exemplary embodiment.

FIG. 5 is an electron microscopic image illustrating that silicon nanoparticles are included in a carbon nanotube film in accordance with an exemplary embodiment.

FIG. 6 is a diagram illustrating flexibility of a carbon nanotube film in accordance with an exemplary embodiment.

FIG. 7 is a diagram illustrating flexibility of a solid electrolyte in accordance with an exemplary embodiment.

FIG. 8 is a graph showing charge and discharge characteristics of a carbon nanotube film depending on an after-treatment in accordance with an exemplary embodiment.

FIG. 9 illustrates a shape of a protective film for protecting a lithium secondary battery in accordance with an exemplary embodiment.

FIG. 10 is a diagram of a lithium secondary battery completed using a method for manufacturing a lithium secondary battery in accordance with an exemplary embodiment.

FIG. 11 illustrates a structure of a fiber-type secondary battery in accordance with an exemplary embodiment.

FIG. 12 is a flowchart provided to explain a method for manufacturing a fiber-type lithium secondary battery using a fiber-type carbon nanotube in accordance with an exemplary embodiment.

FIG. 13 is an electron microscopic image of a carbon nanotube fiber in accordance with an exemplary embodiment.

FIG. 14 is a diagram of a fiber-type lithium secondary battery manufactured using a method for manufacturing a fiber-type lithium secondary battery in accordance with an exemplary embodiment.

### DETAILED DESCRIPTION

Hereinafter, embodiments of the present disclosure will be described in detail with reference to the accompanying drawings so that the present disclosure may be readily implemented by those skilled in the art. However, it is to be noted that the present disclosure is not limited to the embodiments described herein and can be embodied in various other ways. In the drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, the term “comprises or includes” and/or “comprising or including” used in the document means that one or more other components, steps, operation and/or existence or addition of elements are not excluded in addition to the described components, steps, operation and/or elements, unless the context dictates otherwise.

Hereinafter, a lithium secondary battery and a method for manufacturing the same in accordance with an exemplary embodiment of the present disclosure will be described in detail with reference to the accompanying drawings.

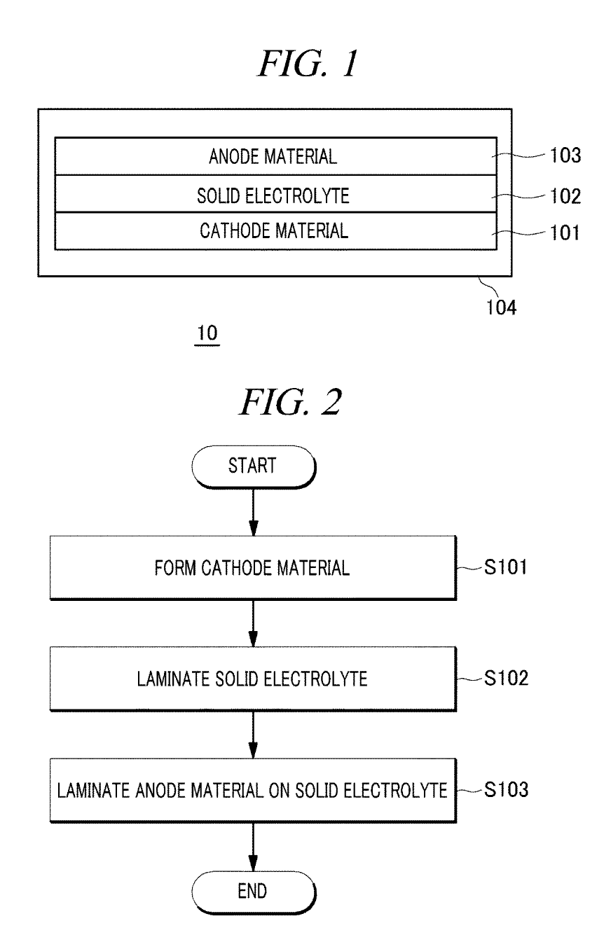

FIG. 1 illustrates a structure of a lithium secondary battery in accordance with an exemplary embodiment.

Referring to FIG. 1, a lithium secondary battery 10 in accordance with an exemplary embodiment includes a cathode material 101, a solid electrolyte 102 laminated on the cathode material 101, an anode material 103 laminated on the solid electrolyte 102, and a protective film 104 surrounding the lithium secondary battery.

The cathode material 101 is formed into a film having a complex structure in which a cathode active material is included in a carbon nanotube film, and does not need a polymer adhesive and a current collector. Herein, for example, LiMnO₂ or LiCoO₂ may be used as the cathode active material.

The solid electrolyte 102 is formed of a polymer, a lithium salt, and an electrolyte in the form of a complex of a fiber web or a polymer electrolyte. Desirably, the solid electrolyte 102 may have a small thickness in order to improve ion conductivity. Herein, it is possible to use a nanoweb formed of other polymers, such as polyester and nylon, and desirably, a fiber constituting the web may have an average diameter of 300 nm or less.

The anode material 103 may be formed of a carbon nanotube film, or may be formed by including an anode active material in a carbon nanotube film if necessary. Further, the anode material 103 may be formed by coating silicon nanoparticles on a carbon nanotube film in order to improve an electrode capacity. The anode material 103 formed of a carbon nanotube film can maintain flexibility in liquid nitrogen at a temperature of −196° C.

The protective film 104 may be a polymer material. For example, the polymer may be polydimethylsiloxane (PDMS). The PDMS is hydrophobic and thus suppresses permeation of moisture. Also, the PDMS is as highly flexible as rubber. The PDMS can be cured by ultraviolet rays or heat.

FIG. 2 is a flowchart provided to explain a method for manufacturing a lithium secondary battery in accordance with an exemplary embodiment in detail.

A method for manufacturing the lithium secondary battery 10 in accordance with an exemplary embodiment includes: forming the cathode material 101 by including a cathode active material in a carbon nanotube film (s101); laminating the solid electrolyte 102 on the cathode material 101 (s102); and laminating the anode material 103 on the solid electrolyte 102 (s103).

In the forming of the cathode material 101 by including a cathode active material in a carbon nanotube film (s101), the cathode material 101 can be manufactured into a film shape having a complex structure by coating a cathode active material on a carbon nanotube film.

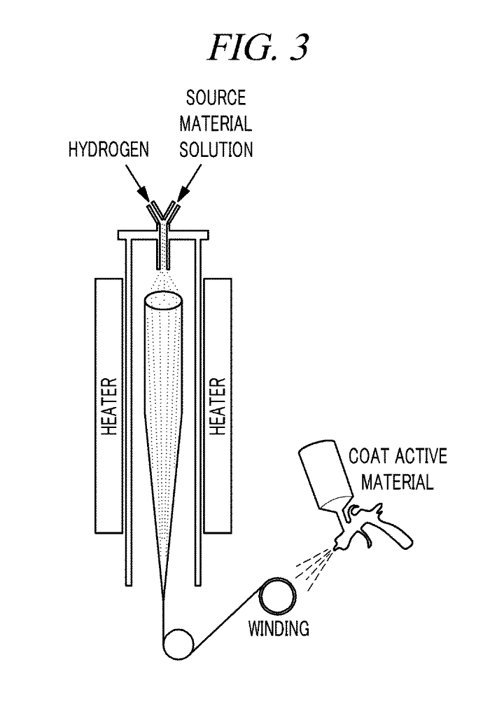

FIG. 3 is a schematic diagram illustrating a process for manufacturing a carbon nanotube film in accordance with an exemplary embodiment.

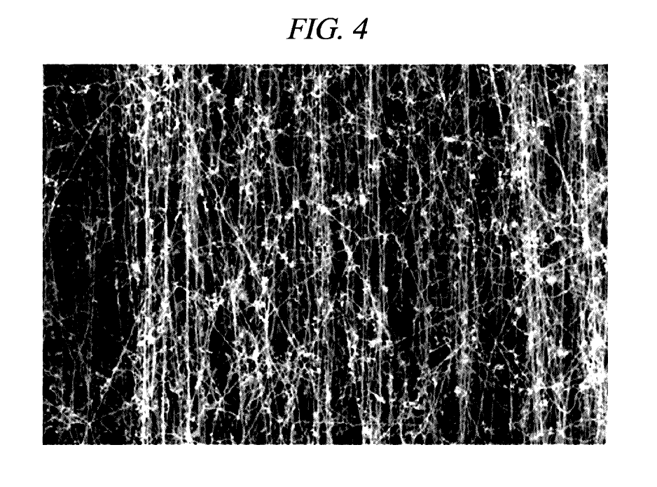

FIG. 4 is an electron microscopic image of a carbon nanotube film manufactured in accordance with an exemplary embodiment.

Referring to FIG. 3 and FIG. 4, a quartz tube placed in a vertical direction is heated to manufacture a carbon nanotube film in accordance with an exemplary embodiment. Then, a high-purity hydrogen gas is allowed to flow into the quartz tube and a small amount of a carbon nanotube synthesis solution is supplied into a vertical synthesis furnace. In this case, the carbon nanotube synthesis solution is a mixture of acetone used as a carbon source, ferrocene as a catalyst precursor, thiophene as an activator, and polysorbate_20 for suppressing agglomeration of a catalyst.

If the synthesis solution is supplied into the synthesis furnace, iron is separated from ferrocene as a catalyst precursor and sulfur is separated from thiophene as an activator by heat energy to form liquid iron-sulfide. Then, carbon atoms supplied by decomposition of acetone are diffused to the iron-sulfide and saturated, so that a carbon nanotube begins to grow. In this case, if the synthesis solution is continuously supplied, carbon nanotubes form a network structured assembly. A carbon nanotube film can be manufactured by winding the assembly around a roller.

Meanwhile, the method for manufacturing a carbon nanotube film in accordance with an exemplary embodiment is described in more detail in Korean Patent Application No. 10-2013-0044173 and PCT Application No. PCT/KR2013/010289.

A carbon nanotube film manufactured in accordance with an exemplary embodiment can be used as the anode material 103 of the lithium secondary battery 10.

To be specific, when the carbon nanotube assembly is wound around the roller, an anode active material or a cathode active material is coated by a direct spinning method and thus can be used as the anode material 103 or the cathode material 101 of the secondary battery 10.

Further, in order to improve an electrode capacity of the anode material 103 in the lithium secondary battery 10, a carbon nanotube film can be formed by coating silicon nanoparticles.

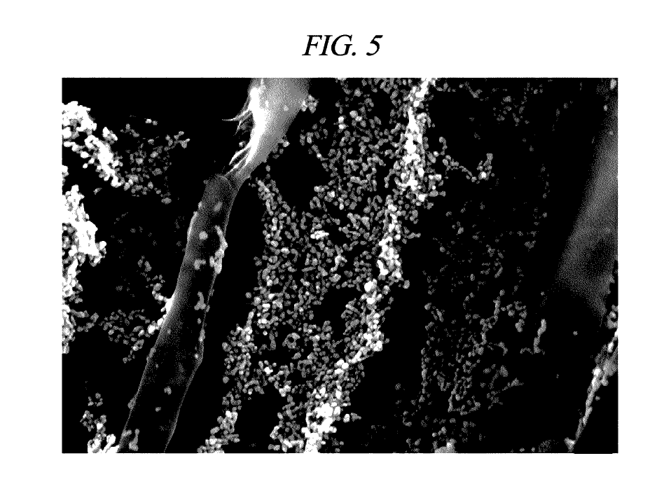

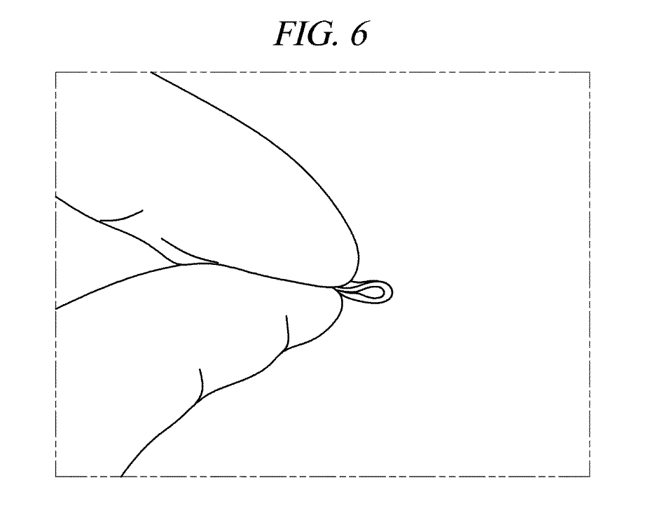

FIG. 5 is an electron microscopic image illustrating a carbon nanotube film including silicon nanoparticles in accordance with an exemplary embodiment.

In accordance with an exemplary embodiment, when a carbon nanotube film to be used in an anode and an anode material is manufactured, a complex film formed by inserting various active materials in a film may be used as an electrode. Thus, various characteristics required for the lithium secondary battery 10 can be implemented.

FIG. 6 is a diagram illustrating flexibility of a carbon nanotube film in accordance with an exemplary embodiment.

As illustrated in FIG. 6, a carbon nanotube film in accordance with an exemplary embodiment is flexible enough to be bent or folded and can maintain flexibility in liquid nitrogen at a temperature of −196° C.

Referring to FIG. 2 again, in the laminating of the solid electrolyte 102 on the cathode material 101 (s102), a polymer, a lithium salt, and an electrolyte in the form of a complex of a fiber web or a polymer electrolyte may be laminated on the cathode material.

For example, the solid electrolyte 102 may be formed by preparing a mixture of ethoxylated trimethylolpropane triacrylate (ETPTA) which can be cross-linked with ultraviolet (UV) rays and a lithium salt, coating the mixture on a polyurethane nanoweb or a polyvinylidene fluoride (PVDF) nanoweb, and cross-linking ETPTA with UV rays. Herein, the nanoweb can be formed of a material such as polyester, nylon, and the like. Herein, a fiber constituting the web may have an average diameter of 300 nm or less. Desirably, the solid electrolyte 102 may have a small thickness in order to improve ion conductivity of the solid electrolyte 102.

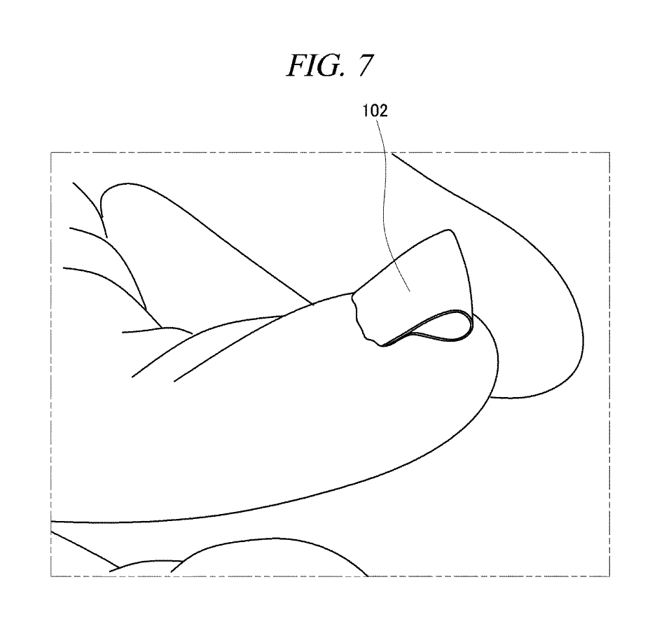

FIG. 7 is a diagram illustrating flexibility of a solid electrolyte in accordance with an exemplary embodiment.

Referring to FIG. 7, it can be seen that the solid electrolyte 102 using a nanoweb in accordance with an exemplary embodiment is very thin and very flexible. Herein, the thickness of the solid electrolyte 102 may vary depending on the amount of a nanoweb to be used. A solid electrolyte of about 10 μm manufactured in accordance with an exemplary embodiment can maintain its shape even after it is folded and unfolded repeatedly 500 times.

Further, the solid electrolyte 102 in accordance with an exemplary embodiment may have a change in ion conductivity depending on the kind of a lithium salt and the thickness of the electrolyte. For example, the solid electrolyte 102 may have an ion conductivity of 10⁻³ S/cm or more at room temperature. Further, the thickness of the nanoweb may vary depending on the molecular weight of the polymer used and the process technology for manufacturing a web. However, desirably, the nanoweb may have a thickness as small as possible in a range in which the nanoweb is not damaged by repeated bending of the solid electrolyte 102.

Various materials may be used as the lithium salt. For example, the lithium salt may be prepared by dissociating lithium hexafluorophosphate (LiPF₆) in ethylene carbonate (EC) and propylene carbonate (PC) prepared at a volume ratio of 1:1 to a concentration of 1 M. As another example, lithium bis-trifluoromethanesulphonimide (LiTFSI) may be dissolved in a reactive additive (succinonitrile, NC—CH₂—CH₂—CN) to a concentration of 1 M by heating at a temperature of 65° C. and then used. However, a technical object to be achieved by the present disclosure is not limited by the kind of lithium salt.

Referring to FIG. 2 again, in the laminating of the anode material 103 on the solid electrolyte 102, a carbon nanotube film or a carbon nanotube film including an anode active material is laminated on the solid electrolyte 102.

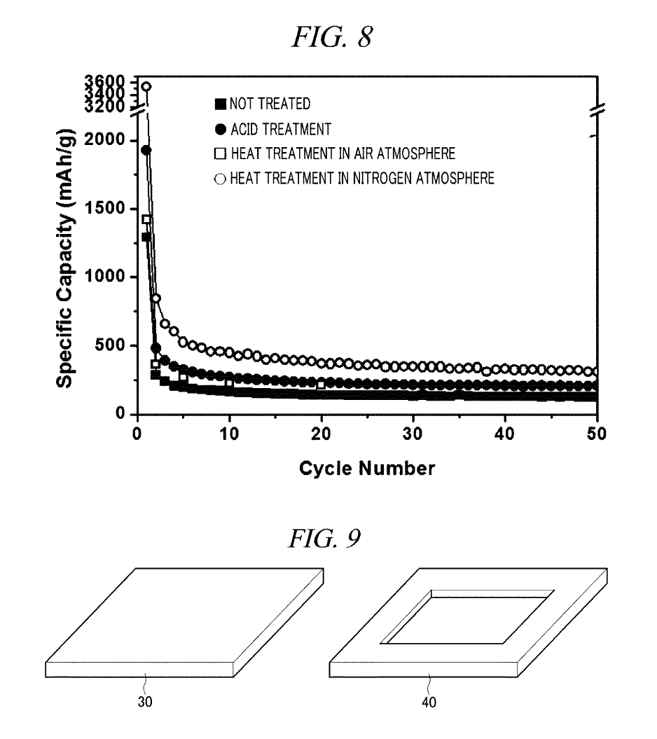

FIG. 8 is a graph showing charge and discharge characteristics of a carbon nanotube film depending on an after-treatment in accordance with an exemplary embodiment.

The anode material 103 of the lithium secondary battery 10 in accordance with an exemplary embodiment may have a change in performance depending on an after-treatment to the carbon nanotube film. The after-treatment may affect the crystallinity of a carbon nanotube, the completeness of a structure, and the content of impurities and thus may cause a change in performance of the lithium secondary battery 10. As illustrated in FIG. 8, charge and discharge characteristics of the anode material 103 may be different when an acid treatment is performed to the carbon nanotube film in aqua regia of 60° C. for 2 hours, when a heat treatment is performed to the carbon nanotube film in air of 200° C., or when a heat treatment is performed to the carbon nanotube film in a nitrogen atmosphere of 1000° C. According to an exemplary embodiment of the present disclosure, it can be seen that when a heat treatment is performed to the carbon nanotube film in a nitrogen atmosphere for 1 hour, the charge and discharge characteristics are improved.

Meanwhile, the method for manufacturing the lithium secondary battery 10 in accordance with an exemplary embodiment may further include immersing the anode material 103 and the cathode material 101 in a mixed solution including ETPTA and a lithium salt and then curing them in order to improve a lithium ion diffusion speed between the solid electrolyte 102 and the electrode.

Further, in the lithium secondary battery 10 in accordance with an exemplary embodiment, the protective film 104 may be formed by packaging using a polymer. Herein, the polymer may be, for example, polydimethylsiloxane (PDMS). The PDMS is hydrophobic and thus suppresses permeation of moisture. Also, the PDMS is as highly flexible as rubber. Further, the PDMS can be cured by UV rays or heat.

FIG. 9 illustrates the shape of a protective film for protecting a lithium secondary battery in accordance with an exemplary embodiment.

As for the protective film 104 of the lithium secondary battery 10 in accordance with an exemplary embodiment, an appropriate amount of PDMS is poured into a square mold to form an upper plate 30 and a lower plate 40 into a square shape and a heat treatment is performed to cure them. Herein, the sizes of the upper plate 30 and the lower plate 40 are determined by the amount of an electrode, and the amount of the electrode varies depending on the amount of energy required.

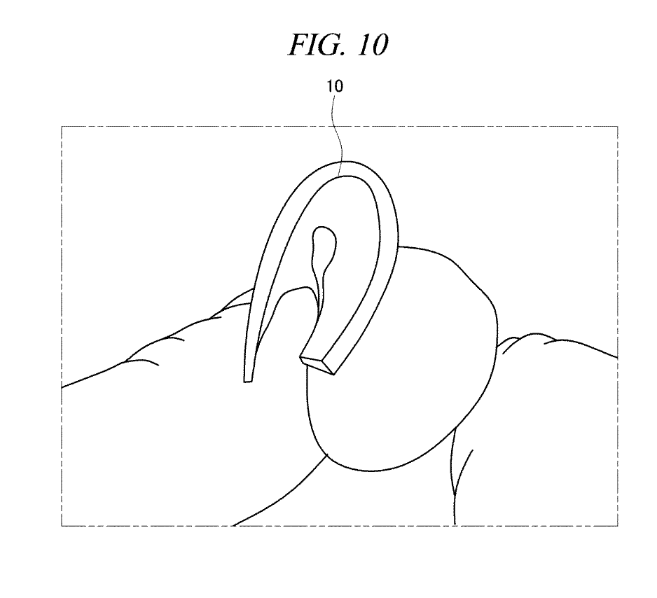

FIG. 10 is a diagram of a lithium secondary battery completed using a method for manufacturing a lithium secondary battery in accordance with an exemplary embodiment.

The lithium secondary battery 10 manufactured in accordance with an exemplary embodiment is flexible enough to be folded or bent as illustrated in FIG. 10. Further, a current collector and a polymer adhesive are not used in manufacturing the lithium secondary battery 10, and, thus, the lithium secondary battery 10 can have a large capacity and light weight. The lithium secondary battery 10 can be used not only for a wearable electronic device, but also for a smart card, a RFID tag, a wireless sensor, and the like.

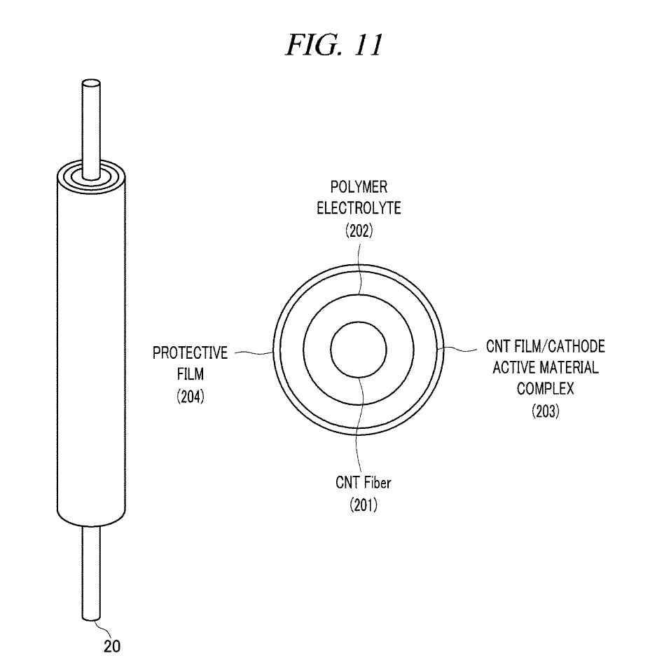

FIG. 11 illustrates a structure of a fiber-type secondary battery in accordance with an exemplary embodiment.

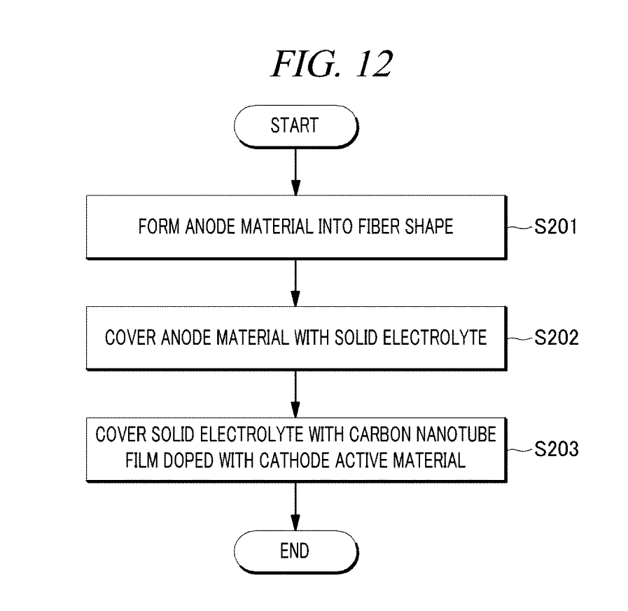

FIG. 12 is a flowchart provided to explain a method for manufacturing a fiber-type lithium secondary battery using a fiber-type carbon nanotube in accordance with an exemplary embodiment.

As illustrated in FIG. 11, a fiber-type lithium secondary battery 20 has a concentric-circle structure, and includes an anode material 201, a solid electrolyte 202 covering the anode material 201, a cathode material 203 covering the solid electrolyte 202, and a protective film 204 surrounding them. Herein, the positions of the anode and the cathode may be reversed.

Referring to FIG. 12, a method for manufacturing a fiber-type lithium secondary battery in accordance with an exemplary embodiment includes: forming an anode material into a fiber shape (s201); covering the anode material with a solid electrolyte (s202); and covering the solid electrolyte with a carbon nanotube film including a cathode active material (s203).

First, in the forming of an anode material into a fiber shape (s201), a carbon nanotube film or a carbon nanotube film including an anode active material is manufactured by the above-described method illustrated in FIG. 3 and then twisted many times to form a carbon nanotube into a fiber-shaped anode material. Additionally, the fiber shaped anode material may include a conducting wire on which the twisted carbon nanotube film is wound. In other words, the fiber-shaped carbon nanotube may be wound in the form of a coil around a conducting wire to form the fiber-shaped anode material. Herein, the conducting wire may be, for example, a copper wire.

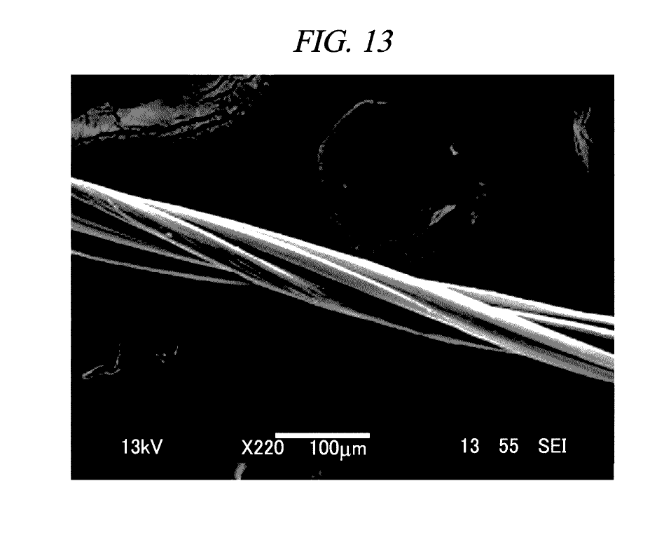

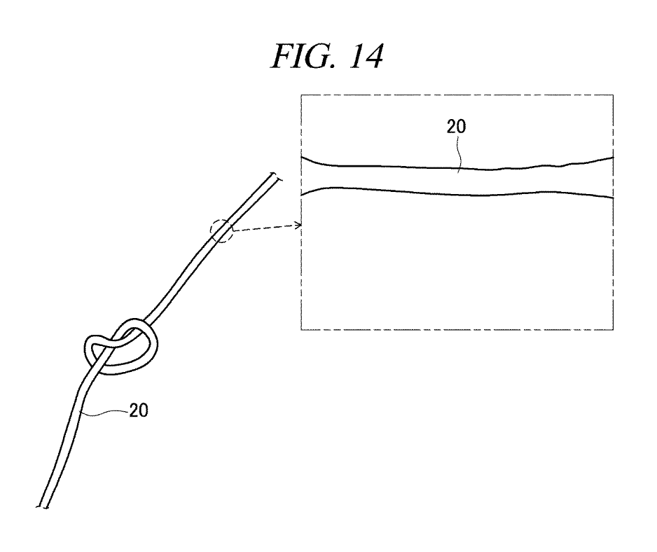

FIG. 13 is an electron microscopic image of a carbon nanotube fiber in accordance with an exemplary embodiment.

If a carbon nanotube film manufactured in accordance with an exemplary embodiment is twisted many times, a flexible carbon nanotube fiber in the form of fiber as illustrated in FIG. 13 can be manufactured.

Turning back to FIG. 12, in the covering of the anode material with a solid electrolyte (s202), the anode material is coated with a mixture of ETPTA and a lithium salt, and then cured with UV rays to form the solid electrolyte 202 on a surface of the anode material 201. The solid electrolyte 202 functions as a separation membrane that suppresses a contact between the anode and the cathode.

Then, the solid electrolyte 202 is covered with a carbon nanotube film including a cathode active material (s203).

Finally, although not illustrated, the protective film 204 of the fiber-type lithium secondary battery 20 in accordance with an exemplary embodiment may be formed by packaging using a polymer. For example, the polymer may be polydimethylsiloxane (PDMS). The PDMS is hydrophobic and thus suppresses permeation of moisture. Also, the PDMS is as highly flexible as rubber. The PDMS can be cured by ultraviolet rays or heat.

Further, in order to implement the characteristics required for the fiber-type lithium secondary battery 20, when anode and cathode carbon nanotube films are manufactured, a complex film formed by inserting various active materials in a film may be used as an electrode.

Furthermore, in order to improve adhesion and ion conductivity between an electrode and an electrolyte, an anode film and a cathode film may be immersed in a solution including ETPTA and a lithium salt, and cured and then used as electrodes.

FIG. 14 is a diagram of a fiber-type lithium secondary battery manufactured using a method for manufacturing a fiber-type lithium secondary battery in accordance with an exemplary embodiment.

As illustrated in the drawing, the fiber-type lithium secondary battery 20 in accordance with an exemplary embodiment is flexible enough to be knotted. The electrodes can maintain flexibility in liquid nitrogen at a temperature of −196° C., and PDMS as the protective film can maintain flexibility even at a temperature of −100° C.

Hereinafter, the present disclosure will be will be described in detail with reference to examples. However, the examples can be modified in various ways and the scope of the present disclosure may not be limited to the following examples.

### Example 1

Carbon nanotube films used as a cathode and an anode were manufactured using the method illustrated in FIG. 3. A carbon nanotube synthesis solution used herein included 98.0% acetone, 0.2% ferrocene, 0.8% thiophene, and 1.0% polysorbate_20 on a weight basis. The synthesis solution was injected at a speed of 10 ml/h into a vertical electrical furnace heated to a temperature of 1200° C. Together with the synthesis solution, high-purity hydrogen was injected at a speed of 1000 sccm to manufacture a carbon nanotube film. A carbon nanotube film alone can be used as an anode material of a lithium secondary battery. Thus, the carbon nanotube film was dried at 200° C. for 6 hours and then used. The dried carbon nanotube film was immersed in an electrolyte for 1 hour, and then a sheet of carbon nanotube film to function as a current collector was attached to a bottom surface of the electrode. Then, the anode material was cured by irradiation with a UV irradiator having a wavelength of 365 nm for 30 seconds. The thickness of the manufactured anode material was about 100 μm.

A solid electrolyte was formed by mixing 85% ETPTA which can be cross-linked with UV rays and 15% lithium salt solution. The lithium salt was prepared by dissociating lithium hexafluorophosphate (LiPF₆) in a solution including ethylene carbonate and propylene carbonate at a volume ratio of 1:1 to a concentration of 1 M. Then, 2-hydroxy-2-methyl-1-phenyl-1-propanon (HMPP) as a photo-initiator was added to the electrolyte solution in the amount of 0.2% with respect to the weight of ETPTA.

A polyurethane nanoweb (average fiber diameter of 300 nm, thickness of 5 μm) was immersed in the electrolyte, and surplus electrolyte was squeezed. Then, the electrolyte was cured by irradiation with a UV lamp having a wavelength of 365 nm for 30 seconds and then used as an electrolyte and a separation membrane between the cathode and the anode. After curing, the complex electrolyte had a thickness of about 10 μm.

A cathode material was prepared by coating a cathode active material between films when the carbon nanotube films were synthesized. The cathode material was dried in a drier at 200° C. for 6 hours and immersed in the electrolyte and then used. Like the anode material, a carbon nanotube film was attached to one surface of the cathode material to function as a current collector. The cathode material was cured by irradiation with a UV irradiator having a wavelength of 365 nm to a thickness of about 100 μm. A cathode active material used for preparing the cathode material was lithium manganese dioxide (LiMnO₂), and this active material was prepared at a concentration of 40 g/l in a solvent N-methylpyrrolidone (NMP). This solution was coated between the carbon nanotube films using a nitrogen sprayer to manufacture a carbon nanotube complex film electrode.

A polydimethylsiloxane (PDMS) film for sealing the electrode materials and the electrolyte was prepared using a SYLGARD 184 silicone elastomer kit (Dow Corning). A rectangular parallelepiped acrylic plate having a thickness of 200 μm was placed at the center of a lower plate having a thickness of 300 μm and then cured. Herein, a copper thin film to be used as a lead wire was attached to a lower end of the acrylic plate. Herein, the lead wire had a length long enough to be protruded to the outside of the lower plate. Independently, a PDMS upper film having a thickness of 300 μm was prepared.

Then, the anode material was placed at the center of the lower plate, and then the solid electrolyte was placed thereon. Then, the cathode material was placed on the solid electrolyte and an aluminum thin film to be used as a lead wire was placed thereon. Herein, the thin film was set to be protruded to the outside of the upper plate. Then, the upper plate was thin-film-coated with a PDMS solution and then placed on the cathode material and cured by heating at 60° C. for 2 hours to manufacture a lithium secondary battery.

### Example 2

Example 2 was the same as Example 1 except that a complex anode material was prepared. A complex anode film was prepared by coating silicon between carbon nanotube films. To this end, silicon was prepared to a concentration of 0.25 g/L in an acetone solution. Then, the solution in which silicon was mixed with acetone was strongly ultrasonicated with a ultrasonicator for 1 hour. Then, this solution was coated on the carbon nanotube films using a nitrogen sprayer. The silicon used herein had an average diameter of 25 nm, and the amount of the silicon solution sprayed to form the anode material to 100 μm was 32 ml. The silicon solution in the amount of about 0.82 ml was coated onto a sheet of film. This silicon solution was dried in a drier at 200° C. for 6 hours and then used as an anode material. The other processes of Example 2 were the same as those of Example 1.

### Example 3

Example 3 was the same as Example 1 except that a complex anode material was prepared to form a battery advantageous for fast charge and discharge. A complex anode film was prepared by coating lithium titanate oxide (LTO) between carbon nanotube films. To this end, LTO was prepared to a concentration of 40 g/L in a N-methylpyrrolidone (NMP) solution. Then, the solution in which LTO was mixed with NMP was strongly ultrasonicated with a ultrasonicator for 1 hour. Then, the solution was coated between the carbon nanotube films using a nitrogen sprayer. The amount of the solution sprayed to form the anode material to 100 μm was 32 ml. The solution in the amount of about 0.82 ml was coated onto a sheet of film. This solution was dried in a drier at 200° C. for 6 hours and then used as an anode material.

### Example 4

Example 4 was the same as Example 1 except the composition of the electrolyte. As a lithium salt, lithium bis-trifluoromethanesulphonimide (LiTFSI) was dissolved by heating in succinonitrile (SN(NC—CH₂—CH₂—CN)) to a concentration of 1 M, and then mixed with ETPTA at a weight ratio of 15:85. This polymer electrolyte was used instead of the electrolyte used in Example 1. In order for the solid electrolyte to express a higher modulus, a poly-vinylidenedifluoride (PVDF) nanoweb (average diameter of 250 nm, thickness of 5 μm) was used instead of the polyurethane nanoweb.

### Example 5

Example 5 was the same as Example 1 except for a pre-treatment to an anode film. A carbon nanotube film was placed in an electrical furnace with a nitrogen atmosphere. After a temperature was increased to 1000° C. at a speed of 10° C. per minute, a heat treatment was performed to the carbon nanotube film for 1 hour. After the heat treatment, the weight of the carbon nanotube film was decreased by about 20%, but its crystalline quality was improved. Thus, the characteristics of the carbon nanotube film as an anode material were improved. According to the Raman analysis, in the heat-treated anode film, the ratio of a G peak and a D peak was increased by about 2 times as compared with a non-treated anode film. The heat-treated film was used as an anode material.

### Example 6

In Example 6, a fiber-type lithium secondary battery was manufactured and the same anode material, cathode material, and electrolyte as those of Example 1 were used. However, Example 6 was different from Example 1 in that a lithium secondary battery was formed into a fiber shape. The 1 m carbon nanotube film manufactured in Example 1 was twisted 200 times to be deformed into a fiber shape. A copper wire to be used as a lead wire was wound in the form of a coil around the fiber. The coil-shaped fiber-type carbon nanotube anode material was wound with the same solid electrolyte and polyurethane complex as those of Example 1 and then cured by irradiation of UV rays for 30 seconds. Then, the solid electrolyte was covered with a cured complex cathode film, and then the cathode material was covered with a sheet of carbon nanotube film to function as a current collector. A metallic lead wire was connected to the cathode current collector, and the outermost periphery of the fiber-type secondary battery was coated with PDMS and cured to complete a fiber-type lithium secondary battery.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

It shall be understood that all modifications and embodiments conceived from the meaning and scope of the claims and their equivalents are included in the scope of the present disclosure.

We claim:

1. A lithium secondary battery comprising:
a cathode material;
a solid electrolyte laminated on the cathode material; and
an anode material laminated on the solid electrolyte,
wherein the cathode material is formed by including a cathode active material in a carbon nanotube film, and
the anode material is formed by including a carbon nanotube film or including an anode active material in a carbon nanotube film.

2. The lithium secondary battery of claim 1,
wherein the solid electrolyte is formed of a polymer, a lithium salt, and an electrolyte in the form of a complex of a fiber web or a polymer electrolyte.

3. The lithium secondary battery of claim 2,
wherein the electrolyte in the form of a complex of a fiber web is formed of a mixture of ethoxylated trimethylolpropane triacrylate (ETPTA) which can be cross-linked with UV rays and a lithium salt.

4. The lithium secondary battery of claim 1,
wherein the cathode active material is LiMnO₂ or LiCoO₂.

5. The lithium secondary battery of claim 1, further comprising:
a protective film surrounding the cathode material, the solid electrolyte, and the anode material.

6. A fiber-type lithium secondary battery comprising:
an anode material;
a solid electrolyte covering the anode material; and
a cathode material covering the solid electrolyte,
wherein the cathode material is formed by including a cathode active material in a carbon nanotube film, and
the anode material is formed into a fiber shape by twisting a carbon nanotube film or a carbon nanotube film including an anode active material.

7. The fiber-type lithium secondary battery of claim 6,
wherein the solid electrolyte is formed of a polymer, a lithium salt, and an electrolyte in the form of a complex of a fiber web.

8. The fiber-type lithium secondary battery of claim 7,
wherein the electrolyte in the form of a complex of a fiber web is formed of a mixture of ethoxylated trimethylolpropane triacrylate (ETPTA) which can be cross-linked with UV rays and a lithium salt.

9. The fiber-type lithium secondary battery of claim 6,
wherein the cathode active material is LiMnO₂ or LiCoO₂.

10. The fiber-type lithium secondary battery of claim 6, further comprising:
a protective film surrounding the cathode material, the solid electrolyte, and the anode material.

11. The fiber-type lithium secondary battery of claim 6,
wherein the fiber shaped anode material includes a conducting wire on which the twisted carbon nanotube film is wound.

12. A method for manufacturing a lithium secondary battery, comprising:
forming a cathode material by including a cathode active material in a carbon nanotube film;
laminating a solid electrolyte on the cathode material; and
laminating an anode material on the solid electrolyte,
wherein the laminating of the anode material is performed by including a carbon nanotube film or including an anode active material in a carbon nanotube film.

13. The method for manufacturing a lithium secondary battery of claim 12,
wherein the laminating of the anode material further includes:
immersing the carbon nanotube film of the anode material in a lithium salt mixed solution and then curing the carbon nanotube film.

14. The method for manufacturing a lithium secondary battery of claim 13,
wherein the carbon nanotube film is formed by coating silicon nanoparticles to improve an electrode capacity of the lithium secondary battery.

15. The method for manufacturing a lithium secondary battery of claim 12,
wherein the laminating of the cathode material further includes:
immersing the carbon nanotube film of the cathode material in a lithium salt mixed solution and then curing the carbon nanotube film.

16. The method for manufacturing a lithium secondary battery of claim 12, further comprising:
forming a protective film surrounding the cathode material, the solid electrolyte, and the anode material.

17. The method for manufacturing a lithium secondary battery of claim 12,
wherein the solid electrolyte is formed by coating a mixture of a polymer and a lithium salt on a nanoweb and cross-linking the solid electrolyte with UV rays.

18. A method for manufacturing a fiber-type lithium secondary battery, comprising:
forming an anode material into a fiber shape;
covering the anode material with a solid electrolyte; and
covering the solid electrolyte with a carbon nanotube film including a cathode active material,
wherein the forming of an anode material into a fiber shape includes
manufacturing a carbon nanotube fiber by twisting a carbon nanotube film or a carbon nanotube film including an anode active material.

19. The method for manufacturing a fiber-type lithium secondary battery of claim 18, further comprising:
manufacturing an anode material by winding the carbon nanotube fiber in the form of a coil around a conducting wire.

20. The method for manufacturing a fiber-type lithium secondary battery of claim 18,
wherein the covering of the anode material further includes:
immersing the carbon nanotube fiber of the anode material in a lithium salt mixed solution and then curing the carbon nanotube fiber.

21. The method for manufacturing a fiber-type lithium secondary battery of claim 20,
wherein the carbon nanotube fiber is formed by including silicon nanoparticles to improve an electrode capacity of the lithium secondary battery.

22. The method for manufacturing a fiber-type lithium secondary battery of claim 18,
wherein the covering the solid electrolyte with a carbon nanotube film including a cathode active material further includes:
immersing the carbon nanotube film including a cathode active material in a lithium salt mixed solution and then curing the carbon nanotube fiber.

23. The method for manufacturing a fiber-type lithium secondary battery of claim 18,
wherein the solid electrolyte is formed by coating a mixture of a polymer and a lithium salt on a nanoweb and cross-linking the nanoweb with UV rays.

24. The method for manufacturing a fiber-type lithium secondary battery of claim 18, further comprising:
forming a protective film surrounding the carbon nanotube film including a cathode active material, the solid electrolyte, and the anode material.
